(19) United States
(12) Patent Application Publication
(10) Pub. No.: US 2020/0265371 A1
(43) Pub. Date: Aug. 20, 2020

(54) SYSTEMS AND METHODS FOR FILLING DRIVER POSITIONS

(71) Applicant: TREAD INC., Toronto (CA)

(72) Inventors: Noah Dolgoy, Toronto (CA); Alicia Francis, Toronto (CA); Simon Ho Ming Chong, North York (CA); Vivekanand Ravichandran, Brampton (CA); Edmond Siu Ching Lau, Toronto (CA)

(21) Appl. No.: 16/794,914

(22) Filed: Feb. 19, 2020

Related U.S. Application Data
(60) Provisional application No. 62/807,440, filed on Feb. 19, 2019.

(51) Int. Cl. G06Q 10/06; G08G 1/00; H04W 4/029

(52) U.S. Cl. CPC G06Q 10/063118; G06Q 10/063114; G06Q 50/30; G08G 1/202; H04W 4/029; G06Q 10/063116

(57) ABSTRACT

An example server fills driver positions for a job. The server is to create a job owned by a head dispatcher including a total number of driver positions; send, to an intermediary dispatcher, a confirmation request to confirm an assignment of the intermediary dispatcher to fill an intermediary number of the total number of driver positions; responsive to an affirmative response, store a dispatcher association between the intermediary dispatcher and the intermediary number of driver positions; create an intermediary job owned by the intermediary dispatcher, the intermediary job including the intermediary number of driver positions to fill; receive driver assignments from the head dispatcher and the intermediary dispatcher; store, based on the driver assignments, driver associations between driver identifiers and the driver positions; and output a driver roster indicating driver information for the driver in each driver position.

### FIELD

The specification relates generally to dispatching systems, and more particularly to dispatching systems and methods for filling driver positions, including sub-dispatching capabilities.

### BACKGROUND

In construction industries, the delivery of materials can be a challenge. Tight timelines and busy highways allow little room to compensate for errors. Present systems may present inefficiencies in passing filling driver positions and communicating job information and driver information from sources to recipients.

### SUMMARY

According to an aspect of the present specification, a server for filling driver positions for a job includes: a memory storing a job repository; a communications interface; a processor interconnected with the memory and the communications interface, the processor to: create, in the job repository, a job owned by a head dispatcher, the job including a total number of driver positions to fill; send, to at least one intermediary dispatcher, a confirmation request to confirm an assignment of the at least one intermediary dispatcher to fill an intermediary number of the total number of driver positions of the job; responsive to an affirmative response to the confirmation request, store a dispatcher association between the at least one intermediary dispatcher and the intermediary number of driver positions to fill; create, in the job repository, for each intermediary dispatcher, an intermediary job owned by the intermediary dispatcher, the intermediary job including the intermediary number of driver positions to fill; receive, via the communications interface, driver assignments from the head dispatcher and the at least one intermediary dispatcher; store, based on the driver assignments, driver associations between driver identifiers and the driver positions; and output a driver roster for the job based on the driver associations, the driver roster indicating, for each driver position of the job, driver information based on the driver identifier associated with the driver position.

According to another aspect of the present specification, a method for filling driver positions for a job includes: creating, in a job repository, a job owned by a head dispatcher, the job including a total number of driver positions to fill; sending, to at least one intermediary dispatcher, a confirmation request to confirm an assignment of the at least one intermediary dispatcher to fill an intermediary number of the total number of driver positions of the job; responsive to an affirmative response to the confirmation request, storing a dispatcher association between the at least one intermediary dispatcher and the intermediary number of driver positions to fill; creating, in the job repository, for each intermediary dispatcher, an intermediary job owned by the intermediary dispatcher, the intermediary job including the intermediary number of driver positions to fill; receiving driver assignments from the head dispatcher and the at least one intermediary dispatcher; storing, based on the driver assignments, driver associations between driver identifiers and the driver positions; and outputting a driver roster for the job based on the driver associations, the driver roster indicating, for each driver position of the job, driver information based on the driver identifier associated with the driver position.

### BRIEF DESCRIPTION OF DRAWINGS

Implementations are described with reference to the following figures, in which:

FIG. 1 depicts a system for filling driver positions for a job;

FIG. 2 depicts certain internal components of a server in the system of FIG. 1;

FIG. 3 depicts a method for filling driver positions in the system of FIG. 1;

FIG. 4 depicts a method of generating a driver roster in the system of FIG. 1;

FIG. 5 depicts a method of displaying a real-time map in the system of FIG. 1;

FIGS. 6A and 6B depict methods of updating driver statuses during performance of the method of FIG. 5; and

FIG. 7 depicts a method of managing jobs at a mobile device in the system of FIG. 1.

### DETAILED DESCRIPTION

In accordance with the present specification, a system for filling and managing driver positions for delivery of bulk material (i.e., a job) is provided. Dispatchers may assign drivers directly, or may sub-dispatch driver positions to intermediary dispatchers. The system further provides notification mechanisms to confirm assignment of the intermediary dispatchers and the end drivers to the driver positions. Upon confirmation of assignment, the system may further communicate job details to the drivers. During the job, drivers may use a mobile device application to track their time. The mobile device application may further cooperate with the server to log location data and allow driver routes to be tracked in real time and stored for historical logging purposes.

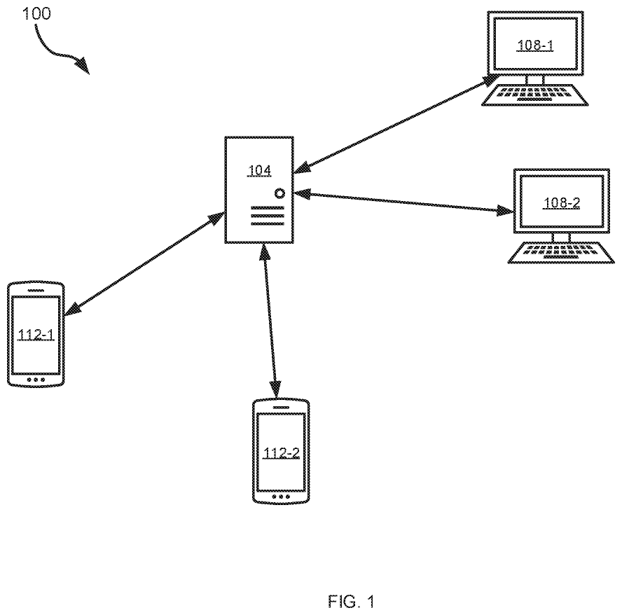

FIG. 1 depicts an example system 100 for filling driver positions for a job. The system 100 includes a server 104, two or more computing devices 108-1, 108-2 (referred to collectively as computing devices 108, and generically as a computing device 108—this nomenclature is used elsewhere herein), and two or more mobile devices 112-1, 112-2.

The server 104 is generally configured to manage jobs and driver assignments. Certain internal components of the server 104 will be described in greater detail below. The server 104 may be based on any suitable server environment, including a stand-alone server, or a cloud-based computing environment. The server 104 may receive a job request from a dispatcher, the job including a total number of driver positions to fill. The server 104 may also receive driver assignments from one or more dispatchers to fill driver positions of the jobs.

The server 104 is thus in communication with the two or more computing devices 108 operated by dispatchers to receive job requests and driver assignments to fill driver positions of the jobs. The computing devices 108 may be desktop computers, laptop computers, servers, kiosks, or other suitable devices, operable by dispatchers to send job requests and driver assignments. In some examples, the computing devices 108 may be mobile computing devices, such as tablets, smart phones, or the like.

The server 104 is also configured to manage driver assignments and dispatch drivers to their assigned jobs. Accordingly, the server 104 is also in communication with the two or more mobile devices 112-1, 112-2 operated by drivers. The mobile devices 112 may be smart phones, tablets, or the like.

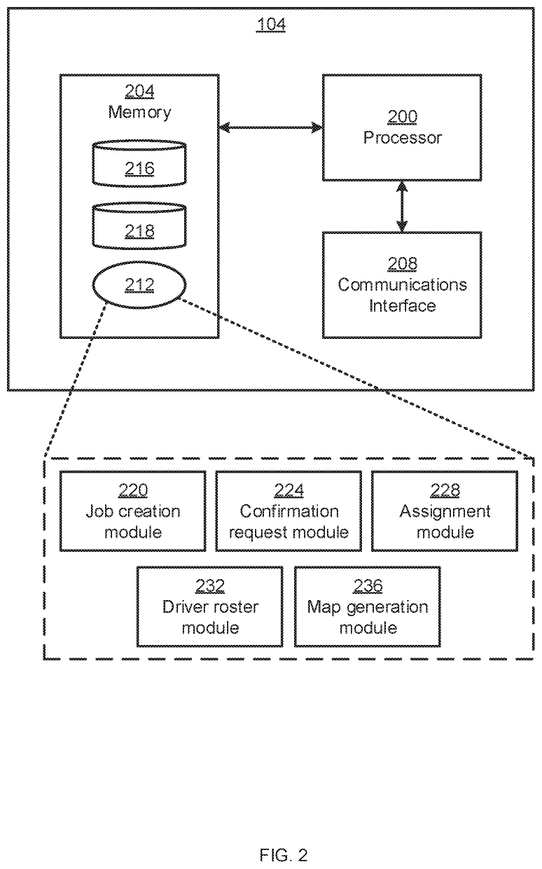

Referring now to FIG. 2, a block diagram of certain internal components of the server 104 is depicted. The server 104 includes a processor 200 interconnected with a non-transitory computer-readable storage medium, such as a memory 204, and a communications interface 208.

The processor 200 may include a central processing unit (CPU), a microcontroller, a microprocessor, a processing core, a field-programmable gate array (FPGA), or similar. The processor 200 may include multiple cooperating processors. The processor 200 may cooperate with the memory 204 to realize the functionality described herein.

The memory 204 may include a combination of volatile (e.g., Random Access Memory or RAM) and non-volatile memory (e.g., read-only memory or ROM, Electrically Erasable Programmable Read Only Memory or EEPROM, flash memory). All or some of the memory 204 may be integrated with the processor 200. The memory 204 stores applications, each including a plurality of computer-readable instructions executable by the processor 200. The execution of the instructions by the processor 200 configures the server 104 to perform the actions discussed herein. In particular, the applications stored in the memory 204 include a job management application 212 to create and manage jobs and driver assignments.

The job management application 212 includes a job creation module 220, a confirmation request module 224, an assignment module 228, a driver roster module 232, and a map generation module 236. As will be apparent, in other examples, the components of the application 212 may be separated into distinct applications or combined into other sets of components. Some or all of the components illustrated as part of the job management application 212 may be implemented as dedicated hardware components, such as one or more FPGAs or application-specific integrated circuits (ASICs).

The job creation module 220 is generally configured to create jobs, including registering an owner of the job and a number of driver positions to fill to complete the job. The confirmation request module 224 is generally configured to control the communications interface 208 to send confirmation requests to intermediary dispatchers or drivers to confirm acceptance of a proposed assignment. The assignment module 228 is generally configured to assign drivers and intermediary dispatchers to jobs based on affirmative responses to confirmation requests. The driver roster module 232 is generally configured to generate a driver roster for a job based on drivers assigned to the job, and drivers assigned by intermediary dispatchers assigned to the job. The map generation module 236 is generally configured to generate maps indicating the locations of drivers based on the driver rosters for jobs. Details of the functionality of the component modules of the application 212 will be described further below.

The memory 204 may further include a job repository 216 and an entity repository 218. The job repository 216 may store job data, including driver assignments, job details, and other relevant data pertaining to specific jobs. The entity repository 218 may store entity data, including entity type (e.g., dispatchers or drivers), entity identifiers (e.g., alphanumeric identifiers (IDs), names, email addresses or the like), license plates, truck configurations, and other relevant data pertaining to specific entities.

The server 104 further includes the communications interface 208 interconnected with the processor 200. The communications interface 208 may be configured for wireless (e.g., satellite, radio frequency, Bluetooth, Wi-Fi, or other suitable communications protocols) or wired communications and may include suitable hardware (e.g., transmitters, receivers, network interface controllers, and the like) to allow the server 104 to communicate with other computing devices, including, but not limited to, the computing devices 108, and the mobile devices 112. The specific components of the communications interface 208 are selected based on the types of communication links that the server 104 communications over.

In some examples, the server 104 may further include one or more input/output devices (not shown), such as a monitor, display, keyboard, mouse, or the like, to allow an operator to interface with the server 104.

In some examples, the server 104 may host a web application to allow remote devices, such as the computing devices 108 to connect to and interface with the server 104 via a web interface. Further, the server 104 may support connection to a local device application to allow computing devices, such as the mobile devices 112 to connect to and interface with the server 104. In particular, where the server 104 receives or sends data to and from the computing devices 108 and/or the mobile devices 112, such transactions may be performed via the web application or the local device application.

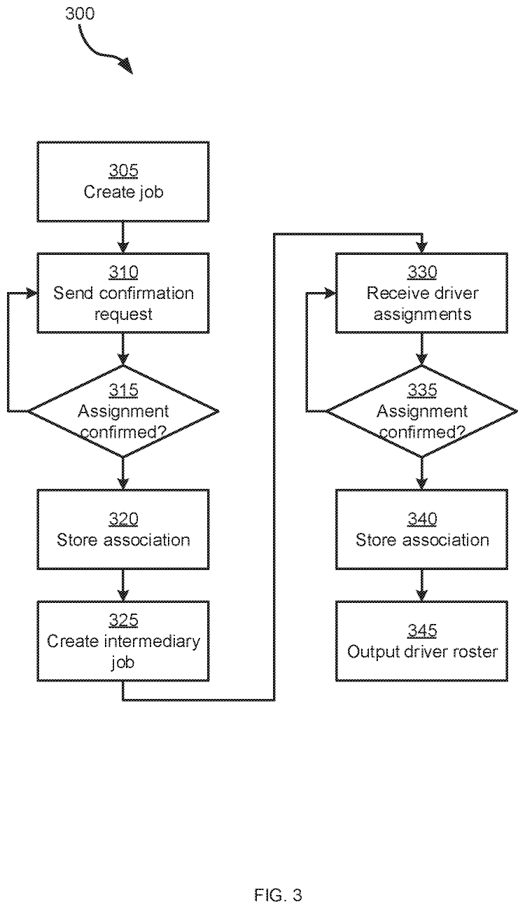

The functionality of the job management application 212 will now be described in greater detail. Turning now to FIG. 3, a flowchart of a method 300 of filling driver positions for a job is shown. The method 300 will be described in conjunction with its performance in the system 100 and with reference to the components illustrated in FIGS. 1 and 2. In other examples, the method 300 may be performed by other suitable systems. Further, it will be appreciated that the method 300 need not be performed in the exact sequence as shown; various blocks may be performed in parallel rather than in sequence, hence the elements of the method 300 are referred to herein as “blocks” rather than “steps”.

The method 300 is initiated at block 305, for example in response to a new job request from a head dispatcher. For example, the server 104, and in particular the communications interface 208, may receive a new job request from the computing device 108, operated, for example, by a head dispatcher. The new job request may specify the details of the job being run by the head dispatcher, including a number of vehicles (and accordingly, driver positions) for the job. Accordingly, at block 305, the server 104, and in particular, the processor 200 via execution of the job creation module 220, creates a new job in the job repository 216.

For example, Table 1 depicts an example of the job repository 216 after receiving a new job request from a head dispatcher for a job.

TABLE1
Job Repository

| | | | | | | Driver |
|---|---|---|---|---|---|---|
| | Driver | | Assigned | | Job ID of | Position ID of |
| Job ID | Position ID | Owner | Entity | Confirmed | parent | parent |
| Job-A | A-1 | Build-It Inc. | | | | |
| Job-A | A-2 | Build-It Inc. | | | | |
| Job-A | A-3 | Build-It Inc. | | | | |
| Job-A | A-4 | Build-It Inc. | | | | |
| Job-A | A-5 | Build-It Inc. | | | | |

As can be seen, the job repository 216 may include a job identifier, a position identifier for the job, an owner of the job. At block 305, the server 104 may generate a job identifier, “Job-A” for the job owned by Build-It Inc. (i.e., the head dispatcher), and registers, in the job repository 216, five lines corresponding to each driver position (A-1 through A-5) for the job. In addition, the job repository 216 may include data for an assigned entity for each driver position, an indication of confirmation of assignment, a job ID of a parent job and a parent driver position ID (i.e., the job and driver position ID from which the current line originated based on sub-dispatching), as will be described further herein.

In other examples, other line, data and/or column configurations are possible. For example, the job repository 216 may further store contact information (e.g., for a foreman or project manager), date, time, and location information of the job (e.g., pick up site, drop off site, scheduled date and time), and other job information (e.g., product or material to be delivered).

At block 310, the server 104 receives, from the computing device 108-1 operated by the head dispatcher, a dispatcher assignment of at least one intermediary dispatcher to fill at least a portion of the driver positions. Specifically, the dispatcher assignment may include an indication of the intermediary dispatcher to assign and an indication of an intermediary number of driver positions of the job to fill.

For example, Table 2 depicts the example job repository 216 after a dispatcher assignment has been received.

TABLE 2
Job Repository

| | | | | | | Driver |
|---|---|---|---|---|---|---|
| | Driver | | Assigned | | Job ID of | Position ID of |
| Job ID | Position ID | Owner | Entity | Confirmed | Parent | Parent |
| Job-A | A-1 | Build-It Inc. | | | | |
| Job-A | A-2 | Build-It Inc. | | | | |
| Job-A | A-3 | Build-It Inc. | Trucks Co. | | | |
| Job-A | A-4 | Build-It Inc. | Trucks Co. | | | |
| Job-A | A-5 | Build-It Inc. | Trucks Co. | | | |

As can be seen, at block 310, the job repository 216 may be updated to reflect a dispatcher assignment assigning three positions (A-3 to A-5) to be filled by an intermediary dispatcher, Trucks Co.

Responsive to the dispatcher assignment, the server 104, and in particular, the processor 200 via execution of the confirmation request module 224 may send, via the communications interface 208, a confirmation request to confirm the assignment of the intermediary dispatcher to fill the intermediary number of driver positions of the job to the intermediary dispatcher operating, for example, the computing device 108-2. The confirmation request may be a text message, an email, a push notification for a mobile device, or other suitable requesting mechanism. In some examples, sending the confirmation request may initiate a timer tracking an allotted time to receive a response from the intermediary dispatcher. In some examples, the confirmation request may further include certain job details (e.g., the date and time of the job, start and end locations, and the like) to allow the intermediary dispatcher to make a more informed decision prior to accepting the assignment.

At block 315, the server 104 receives, via the communications interface 208, a response to the confirmation request.

If, at block 315, the response is negative, the method 300 may return to block 310 to receive a new dispatcher assignment. For example, if the allotted time expires without a confirmation from the intermediary dispatcher, the response at block 315 may be deemed to be negative. In some examples, the method may proceed to block 330, if, instead of a new dispatcher assignment, the server 104 receives driver assignments from the head dispatcher operating the computing device 108-1.

If at block 315, the response is affirmative, the method 300 proceeds to block 320. At block 320, the server 104, and in particular, the processor 200 via execution of the assignment module 228, confirms the assignment of the intermediary dispatcher to the driver positions of the job. Specifically, the processor 200 may store, in the job repository 216, an association (i.e., a dispatcher association) between the intermediary dispatcher and the intermediary number of driver positions to fill. For example, Table 3 depicts the example job repository 216 after storing the association between the intermediary dispatcher and the intermediary number of driver positions to fill based on an affirmative response at block 315.

TABLE 3
Job Repository

| | | | | | | Driver |
|---|---|---|---|---|---|---|
| | Driver | | Assigned | | Job ID of | Position ID of |
| Job ID | Position ID | Owner | Entity | Confirmed | Parent | Parent |
| Job-A | A-1 | Build-It Inc. | | | | |
| Job-A | A-2 | Build-It Inc. | | | | |
| Job-A | A-3 | Build-It Inc. | Trucks Co. | Y | | |
| Job-A | A-4 | Build-It Inc. | Trucks Co. | Y | | |
| Job-A | A-5 | Build-It Inc. | Trucks Co. | Y | | |

As can be seen, in the present example, the association between the intermediary dispatcher and the intermediary number of driver positions to fill may be an indication of confirmation for each of the three driver positions assigned to the intermediary dispatcher, Trucks Co.

Responsive to the acceptance of filling driver positions by the intermediary dispatcher, a new intermediary job may be created for the intermediary dispatcher to fill the intermediary number of driver positions. Accordingly, at block 325, the server 104, and in particular the processor 200 via execution of the job creation module 220, creates a new job in the job repository 216. For example, Table 4 depicts the example job repository 216 after creating a new intermediary job for the intermediary dispatcher.

TABLE 4
Job Repository

| | | | | | | Driver |
|---|---|---|---|---|---|---|
| | Driver | | Assigned | | Job ID of | Position ID of |
| Job ID | Position ID | Owner | Entity | Confirmed | Parent | Parent |
| Job-A | A-1 | Build-It Inc. | | | | |
| Job-A | A-2 | Build-It Inc. | | | | |
| Job-A | A-3 | Build-It Inc. | Trucks Co. | Y | | |
| Job-A | A-4 | Build-It Inc. | Trucks Co. | Y | | |
| Job-A | A-5 | Build-It Inc. | Trucks Co. | Y | | |
| Job-B | B-1 | Trucks Co. | | | Job-A | A-3 |
| Job-B | B-2 | Trucks Co. | | | Job-A | A-4 |
| Job-B | B-3 | Trucks Co. | | | Job-A | A-5 |

As can be seen, at block 325, the server 104 may generate a new job identifier “Job-B” for the intermediary job owned by Trucks Co. (i.e., the intermediary dispatcher), and registers, in the job repository 216, three lines corresponding to each driver position (B-1 through B-3) for the intermediary job. In addition, the server 104 may record the job ID and the driver position ID of the parent job and the parent driver position that each line corresponds to. The intermediary job “Job-B” may be treated as a new job and may iterate through the method 300 to fill the driver positions in the intermediary job. In particular, the intermediary dispatcher may assign another intermediary dispatcher to a number of driver positions in the intermediary job, which in turn may assign another intermediary dispatcher, and so on. That is, each intermediary dispatcher may continue to sub-dispatch, and the sub-dispatching may continue arbitrarily until no further intermediary dispatchers are assigned.

At block 330, the server 104 receives, from one or more of (i) the computing device 108-1 operated by the head dispatcher and (ii) the computing device 108-2 operated by an intermediary dispatcher, driver assignments. Specifically, each driver assignment may include an indication of a driver (e.g., identified by a driver identifier, such as a name, alphanumeric ID, email address, or the like) and the job and driver position to fill. Each dispatching entity may provide driver assignments for positions owned by the respective dispatching entity and not yet assigned. That is, in the above example, Build-It Inc. may provide driver assignments for driver positions A-1 and A-2, and Trucks Co. may provide driver assignments for driver positions B-1, B-2, and B-3. Table 5 depicts the example job repository 216 after driver assignments have been received.

TABLE 5
Job Repository

| | | | | | | Driver |
|---|---|---|---|---|---|---|
| | Driver | | Assigned | | Job ID of | Position ID of |
| Job ID | Position ID | Owner | Entity | Confirmed | Parent | Parent |
| Job-A | A-1 | Build-It Inc. | D-123 | | | |
| Job-A | A-2 | Build-It Inc. | D-234 | | | |
| Job-A | A-3 | Build-It Inc. | Trucks Co. | Y | | |
| Job-A | A-4 | Build-It Inc. | Trucks Co. | Y | | |
| Job-A | A-5 | Build-It Inc. | Trucks Co. | Y | | |
| Job-B | B-1 | Trucks Co. | D-324 | | Job-A | A-3 |
| Job-B | B-2 | Trucks Co. | D-248 | | Job-A | A-4 |
| Job-B | B-3 | Trucks Co. | D-954 | | Job-A | A-5 |

As can be seen, at block 330, the job repository 216 may be updated to reflect driver assignments assigning the remaining positions in both Job-A and Job-B to be filled by drivers.

Responsive to the driver assignments, the server 104, and in particular, the processor 200 via execution of the confirmation request module 224 may send, via the communications interface 208, respective driver confirmation requests to confirm the assignments of the drivers to fill the driver positions. Such driver confirmation requests may be sent, for example, to the mobile devices 112. The driver confirmation requests may be text messages, emails, push notifications, or other suitable requesting mechanisms. In some examples, sending the driver confirmation requests may also initiate a timer tracking an allotted time to receive responses from the drivers. In some examples, the confirmation request may further include certain job details (e.g., the date and time of the job, start and end locations, and the like) to allow the drivers to make a more informed decisions prior to accepting the assignment.

At block 335, the server 104 receives, via the communications interface 208, responses to each respective driver confirmation request. The server 104 evaluates each response individually at block 335.

Specifically, if, at block 335, a given response is negative, the method may return to block 330 to receive new driver assignments. For example, if the allotted time expires without a confirmation from the driver, the response at block 335 may be deemed to be negative.

If, at block 335, a given response is affirmative, the method proceeds to block 340. At block 340, the server, the server 104, and in particular, the processor 200 via execution of the assignment module 228, confirms the assignment of the driver to the driver position of the job. Specifically, the processor 200 may store, in the job repository 216, an association (i.e., driver associations) between the driver identifier (e.g., an alphanumeric identifier, a name, an email address, or the like) representing the driver and the respective driver position. For example, Table 6 depicts the example job repository 216 after storing the association between the driver identifiers and the driver positions.

TABLE 6
Job Repository

| | | | | | | Driver |
|---|---|---|---|---|---|---|
| | Driver | | Assigned | | Job ID of | Position ID of |
| Job ID | Position ID | Owner | Entity | Confirmed | Parent | Parent |
| Job-A | A-1 | Build-It Inc. | D-123 | Y | | |
| Job-A | A-2 | Build-It Inc. | D-234 | Y | | |
| Job-A | A-3 | Build-It Inc. | Trucks Co. | Y | | |
| Job-A | A-4 | Build-It Inc. | Trucks Co. | Y | | |
| Job-A | A-5 | Build-It Inc. | Trucks Co. | Y | | |
| Job-B | B-1 | Trucks Co. | D-324 | Y | Job-A | A-3 |
| Job-B | B-2 | Trucks Co. | D-248 | Y | Job-A | A-4 |
| Job-B | B-3 | Trucks Co. | D-954 | Y | Job-A | A-5 |

As can be seen, in the present example, the association between the driver identifier and the respective driver position may be an indication of confirmation that the driver accepted the assignment to the respective driver position.

At block 345, the server 104, and in particular, the processor 200 via execution of the driver roster module 232 generates and outputs a driver roster for the job. For example, the driver roster module 232 may be initiated for a given job when the given job has drivers assigned to each of the driver positions in the job.

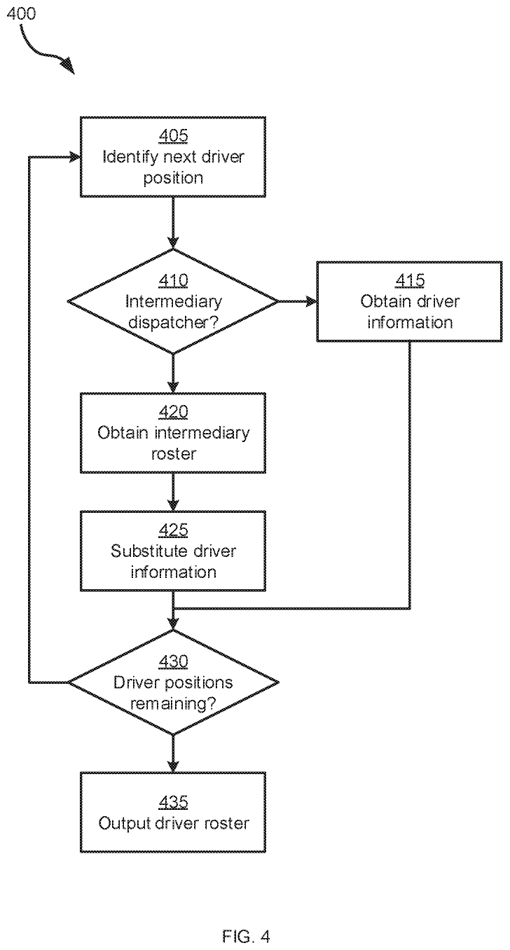

In particular, referring to FIG. 4, a flowchart of an example method 400 of generating and outputting a driver roster at block 345 is depicted. Generally, the driver roster indicates, for each driver position of a job, driver information based on the driver identifier associated with the driver position.

The method 400 is initiated at block 405. Specifically, the method 400 iterates through the driver positions in a job to obtain the driver information for the driver position to assemble the driver roster. Accordingly, at block 405, the server 104 identifies a next driver position. For example, in assembling a driver roster for Job-A, the server 104 would identify, upon initialization of block 405, the position A-1 associated with Job-A.

At block 410, the server 104 determines whether the assigned entity associated with the position A-1 is an intermediary dispatcher. For example, the server 104 may reference the entity repository 218 to determine the entity type associated with the driver ID for the position.

If, at block 410, the server 104 determines that the assigned entity for the position is a driver (i.e., not an intermediary dispatcher), the method 400 proceeds to block 415. At block 415, the server 104 obtains driver information from the entity repository 218 and stores it in the driver roster. For example, Table 7 shows the driver roster for Job-A after iterating through blocks 405-415 for the position A-1.

TABLE 7
Driver Roster for Job-A

| | | | Driver Phone | |
|---|---|---|---|---|
| Position ID | Driver ID | Driver Name | Number | License Plate |
| A-1 | D-123 | John | 416-123-4567 | XXXX 123 |

Upon completion of block 415, the method 400 proceeds to block 430 to iterate through the next driver position for the job. Specifically, at block 430, the server 104 determines whether there are any remaining driver positions for the job which are not yet completed in the driver roster. If the determination at block 430 is affirmative, the method 400 proceeds to block 405 to identify the next driver position.

If, at block 410, the server 104 determines that the assigned entity for the position is an intermediary dispatcher, the method 400 proceeds to block 420. At block 420, the server 104 obtains an intermediary driver roster for the intermediary job owned by the intermediary dispatcher. For example, the server 104 may perform another instance of the method 400 for the intermediary job to obtain the driver roster for the intermediary job.

At block 425, the server 104 obtains the driver information from the intermediary job driver roster for the driver in the corresponding driver position in the parent job and substitutes the driver information in the parent job driver roster. The parent job and parent position for the position in an intermediary job driver roster may be obtained, for example, based on parent data stored in the job repository.

For example, in consideration of position A-3, the server 104 determines at block 410 that the assigned entity, Trucks Co. is an intermediary dispatcher, and proceeds to block 420. At block 420, the server 104 obtains the driver roster for the intermediary job, Job-B, as outlined in Table 8.

TABLE 8
Driver roster for Job-B

| | | | Driver Phone | |
|---|---|---|---|---|
| Position ID | Driver ID | Driver Name | Number | License Plate |
| B-1 | D-324 | Joe | 647-000-1122 | WXYZ 999 |
| B-2 | D-248 | Jess | 289-555-9876 | AABB 456 |
| B-3 | D-954 | Jude | 416-967-1111 | TRUX |

At block 425, the server 104 may correlate the driver position A-3 of Job-A with the driver position B-1 of Job-B, and accordingly, substitutes the driver information for the driver position B-1 into the driver roster of Job-A, in association with the driver position A-3. Thus, for example, the complete driver roster for Job-A is outlined in Table 9.

TABLE 9
Driver roster for Job-A

| | | | Driver Phone | |
|---|---|---|---|---|
| Position ID | Driver ID | Driver Name | Number | License Plate |
| A-1 | D-123 | John | 416-123-4567 | XXXX 123 |
| A-2 | D-248 | Jane | 647-999-1234 | AABB 456 |
| A-3 | D-324 | Joe | 647-000-1122 | WXYZ 999 |
| A-4 | D-248 | Jess | 289-555-9876 | AABB 456 |
| A-5 | D-954 | Jude | 416-967-1111 | TRUX |

The server 104 continues to iterate through each driver position until all the driver positions associated with the job have been added to the driver roster. If, at block 430, no additional driver positions remain to be added to the driver roster, the method 400 proceeds to block 435.

At block 435, the server 104 outputs the driver roster. For example, the driver roster may be displayed on a screen, for example, at the server 104. The driver roster may be stored for further processing, or for access by a computing device 108. In other examples, the driver roster may be sent to the owner of the job, for example via email, push notification, or other suitable notification mechanisms.

As will now be appreciated, the driver roster results in visibility of all the drivers and corresponding driver information associated with a job. Further, by establishing intermediary jobs, driver rosters may be created for each level assignments, allowing visibility and transparency throughout each job. In particular, the driver roster integrates driver information from drivers assigned via intermediary jobs, including intermediary jobs assigned by intermediary dispatchers at arbitrarily successive iterations of sub-dispatching. That is, as many layers of intermediary jobs and the drivers assigned via those intermediary jobs may be integrated to output a single driver roster displaying driver information.

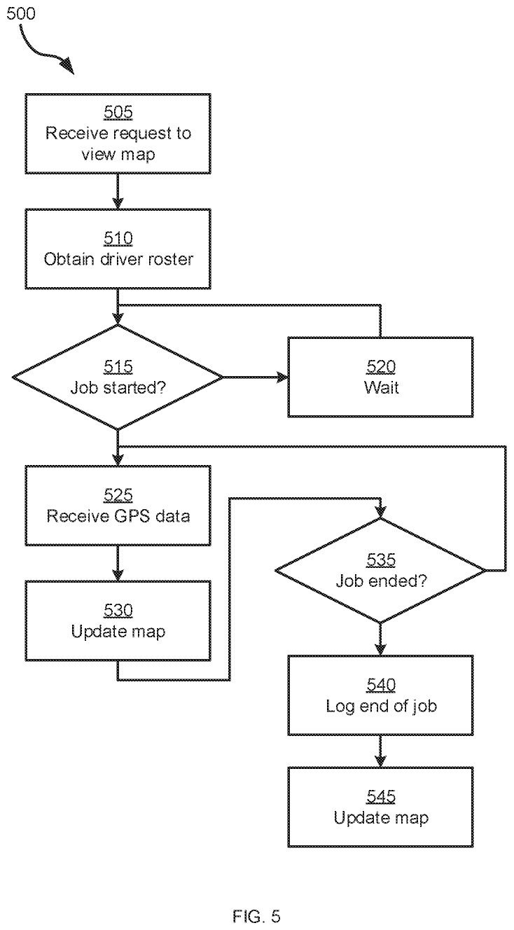

Referring now to FIG. 5, a flowchart of an example method 500 of generating a map in real-time to display locations of drivers on a job is depicted. As will be appreciated, the method 500 may be performed, in some examples, to output a map of the driver roster at block 345 of the method 300.

The method 500 is initiated at block 505, when a request to view a map is received from a requesting entity operating a computing device 108. The request may be received, for example, from the head dispatcher operating the computing device 108-1, or an intermediary dispatcher operating the computing device 108-2. The request received at block 505 may include an identifier of the requesting entity (e.g., an account ID, an entity ID, username, or the like). In some examples, the request may further include a job identifier indicating which job the requesting entity would like to generate a map for.

Generally, a requesting entity may only request generation of a map for jobs owned by the requesting entity. For example, the intermediary dispatcher Trucks Co. may not request generation of a map for Job-A in its entirety, since Trucks Co. does not own Job-A. Such restrictions may be enacted, for example, by restricting the jobs for which maps may be requested by each requesting entity based on the identifier of the requesting entity. Specifically, the restrictions may be enforced at the time of the request.

In other examples, the intermediary dispatcher, Trucks Co. may request generation of a map for Job-A, and upon receipt of the request, the server 104 may identify a viewable job as the intermediary job Job-B sub-dispatched to Trucks Co., and utilize Job-B as the viewable job for which the map is to be generated.

At block 510, the server 104 obtains the job roster for the job identified in block 505. For example, the server 104 may execute the method 400. Alternately, if the driver roster for the job was previously generated and stored in the memory 204, the server 104 may simply retrieve the driver roster from the memory 204.

The method 500 then proceeds to iterate through blocks 515 to 545 for each driver in the driver roster. Accordingly, blocks 515 to 545 will be described in relation to a single driver on the driver roster.

At block 515, the server 104, and in particular, the processor 200 via execution of the map generation module 236, determines whether the job has started for the driver. Different drivers may start on the same job at different times due to different vehicle or loading requirements, different aspects of the job, or simply to offset start times. Accordingly, the map for a given job may only display a driver's location when the driver is on the clock for the given job. The server 104 may make the determination at block 515, for example, based on receipt of a start signal indicating that the driver has started the given job. If such a signal has not yet been received, the determination at block 515 may be negative.

If the determination at block 515 is negative, the server 104 proceeds to block 520 to wait until the job starts.

If the determination at block 515 is affirmative, the server 104 proceeds to block 525. At block 525, the server 104 receives, via the communications interface 208, global positioning system (GPS) data from the mobile device 112 associated with the driver. The GPS data may include a location (e.g., expressed in latitude and longitude coordinates), bearing, altitude, speed, and the like. The server 104 may also log the GPS data with a timestamp indicating the date and time of receipt of the GPS data in the memory 204.

At block 530, responsive to receiving new GPS data at block 525, the server 104 displays the real-time map of drivers associated with the viewable job. Specifically, the server 104 may update the map in real-time with the driver's location. For example, the server 104 may move a marker or indicator of the driver's location to reflect the location as received at block 525. Additionally, the server 104 may provide update the map to reflect a status of the driver (e.g., active, idle, disconnected, or the like), for example based on a color and/or shape of the marker or indicator of the driver's location.

At block 535, the server 104 determines whether the job has ended. Specifically, the server 104 may also receive, at block 525, a signal indicating that the driver has completed the job with final GPS data. If such a signal has been received, the server 104 determines that the job has ended. In other examples, the server 104 may determine that the job has ended when the driver is at a designated end location (i.e., as determined based on most recent location data). The server 104 then proceeds to block 540 and logs completion of the job.

If a job end signal has not yet been received, the determination at block 535 may be negative, and the method 500 proceeds to block 525 to wait for further GPS data.

At block 545, the server 104 updates the map again, in particular, to remove the location of the driver from the map.

It will be appreciated, that in the absence of a request to view a map of driver locations, the server 104 may still execute blocks 515 to 540 of the method 500 for historical tracking, and to allow driver routes and maps to be generated after the job is complete.

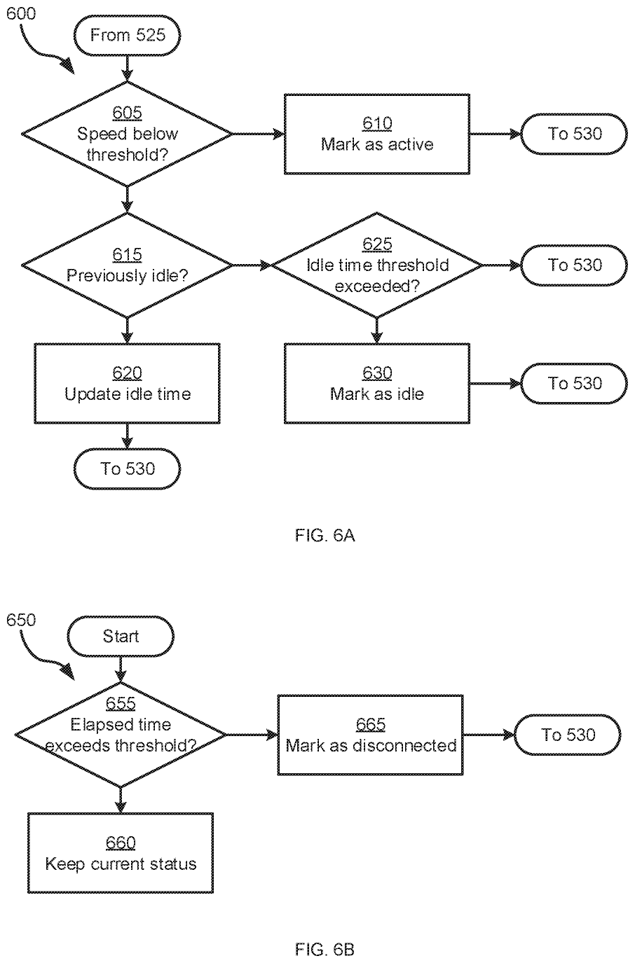

Referring now to FIGS. 6A and 6B, flowcharts of two example methods 600 and 650 of updating a status marker of drivers during generation and/or updates to the map during the performance of the method 500 are depicted.

Specifically, FIG. 6A depicts the method 600 for determining whether a driver is idle.

The method 600 starts at block 605, after receiving GPS data from a mobile device 112 associated with a driver at block 525 of the method 500. At block 605, the server 104 determines whether the speed data of the mobile device 112 received as part of the GPS data is below a threshold, for example 5 km/h. It will be appreciated that in other examples, other speed thresholds may be used. In some examples, if the

If the mobile device 112 is determined to be moving at above the threshold speed, the server 104 proceeds to block 610 and assigns the driver an active status. At block 610, the server 104 may also clear an idle time value stored in the memory 204, to indicate that the driver is no longer idle, as will be described further herein. The server 104 then proceeds to block 530 to update the map.

If, at block 605, the speed of the mobile device 112 is below the threshold, the method 600 proceeds to block 615. At block 615, the server 104 determines whether the mobile device 112 was previously idle. Specifically, the server 104 may check a whether an idle time value exists.

If the idle time value does not exist, the method 600 proceeds to block 620 and updates the idle time with the time that the GPS data was received. Specifically, if the idle time value does not exist, this indicates that the most recently received GPS data is the first instance in which the speed of the mobile device 112 is below the threshold speed, and hence the mobile device 112 cannot be deemed to be idle. Accordingly, the server 104 may maintain the existing status of the driver and proceeds to block 530 to update the map.

If the idle time value does exist, this indicates that the driver was also previously idle at previous receipt of GPS data. Accordingly, the server 104 proceeds to block 625 to determine whether the total idle time exceeds an idle time threshold. Specifically, the total idle time may be computed as the time between the idle time and a current time. Notably, at block 625, the server 104 does not overwrite the idle time so that the idle time value is maintained as the first recorded idle time.

If, at block 625, the total idle time does not exceed the idle time threshold, the mobile device is not yet deemed to be idle. Accordingly, the server 104 may maintain the existing status of the driver and proceeds to block 530 to update the map.

If, at block 625, the total idle time does exceed the idle time threshold, the server 104 proceeds to block 630. At block 630, the server 104 assigns the driver an idle status and updates the map accordingly. For example, an indicator of the driver's location may change color or shape to indicate that the driver is idle at that location.

FIG. 6B depicts the method 650 for determining when a driver is disconnected. The method 650 may be performed during the method 500, for example while waiting for new GPS data to be received at block 525. In some examples, the method 650 may be executed concurrently with the method 500 at predetermined times or time intervals.

The method 650 starts at block 655. At block 655, the server 104 obtains the most recently logged GPS data received at block 525 and determines whether the elapsed time (i.e., the time between the timestamp of the most recently logged GPS data and a current time) exceeds a threshold value. The threshold value may be predetermined as the amount of time above it may be assumed that GPS signals are not being received from the mobile device 112. In other examples, the threshold value may be dynamically generated, for example, based on an average time between contiguous times of receipt of GPS signals.

If the threshold is not exceeded, the server 104 proceeds to block 660 to maintain the current status of the driver.

If the threshold is exceeded, the server 104 proceeds to block 665 to assign the driver a disconnected status, and proceeds to block 530 to update the map. For example, an indicator of the driver's location may change color or shape to indicate that the driver is now disconnected. The indication of the driver's location may be maintained at the most recent known location.

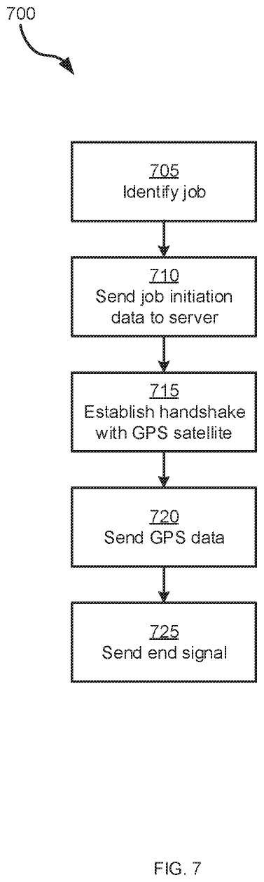

FIG. 7 is a flowchart of an example method 700 of managing jobs at a mobile device, such as the mobile device 112-1 or 112-2, operated by a driver. In particular, the method 700 may be performed by a processor of the mobile device via execution of a local device application stored on a computer-readable medium (e.g., a memory) of the mobile device. Specifically, the method 700 may be performed to allow the mobile device to cooperate with a server (e.g., the server 104) for tracking and updating the driver's job status.

At block 705, the mobile device identifies the job, for example, via input from an operator (i.e., the driver) of the mobile device. For example, the driver may use a touch screen to indicate which job the driver is currently working for.

At block 710, the mobile device sends job initiation data to the server. The job initiation data may include a job identifier, an start signal indicating that the job has been started, and a driver identifier identifying the driver (e.g., an account ID, a driver ID, a username, or the like).

At block 715, responsive to starting the job, the mobile device establishes a handshake with satellites available via the mobile device's carrier to enable GPS data to be received by the mobile device.

At block 720, responsive to receiving GPS data from a satellite, the mobile device sends the GPS data to the server. The mobile device may continue to iterate through block 720 as GPS data is received from the satellite.

At block 725, upon completing the job, the mobile device sends a job end signal to the server. Block 725 may be performed, for example, in response to an input from the driver indicating that the job is complete.

The scope of the claims should not be limited by the embodiments set forth in the above examples, but should be given the broadest interpretation consistent with the description as a whole.

1. A server for filling driver positions for a job, the server comprising:
a memory storing a job repository;
a communications interface;
a processor interconnected with the memory and the communications interface, the processor to:
create, in the job repository, a job owned by a head dispatcher, the job including a total number of driver positions to fill;
send, to at least one intermediary dispatcher, a confirmation request to confirm an assignment of the at least one intermediary dispatcher to fill an intermediary number of the total number of driver positions of the job;
responsive to an affirmative response to the confirmation request, store a dispatcher association between the at least one intermediary dispatcher and the intermediary number of driver positions to fill;
create, in the job repository, for each intermediary dispatcher, an intermediary job owned by the intermediary dispatcher, the intermediary job including the intermediary number of driver positions to fill;
receive, via the communications interface, driver assignments from the head dispatcher and the at least one intermediary dispatcher;
store, based on the driver assignments, driver associations between driver identifiers and the driver positions; and
output a driver roster for the job based on the driver associations, the driver roster indicating, for each driver position of the job, driver information based on the driver identifier associated with the driver position.

2. The server of claim 1, wherein the processor is further configured to prior to storing the driver associations, send, to each driver associated with the driver identifiers, a driver confirmation request to confirm the driver assignment to the driver position.

3. The server of claim 2, wherein the processor is to store each driver association only responsive to an affirmative response to the driver confirmation request.

4. The server of claim 1, wherein to output the driver roster, the processor is to:
for each driver position of the job:
determine if an assigned entity for the driver position is an intermediary dispatcher or a driver;
if the assigned entity is a driver, obtain driver information; and
if the assigned entity is an intermediary dispatcher:
obtain an intermediary driver roster for the intermediary job owned by the intermediary dispatcher; and
substitute driver information from the intermediary driver roster for the driver in a corresponding driver position.

5. The server of claim 1, wherein the processor is further to:
receive a request from a requesting entity to view a real-time map of drivers associated with the job;
determine a viewable job owned by the requesting entity, the viewable job selected from the job and the intermediary job based on the requesting entity;
obtain the driver roster for the viewable job; and
display the real-time map of drivers associated with the viewable job.

6. The server of claim 5, wherein to display the real-time map, the processor is to:
after receiving a start signal from a driver, receive global positioning system (GPS) data including a location of the driver; and
update the real-time map to reflect the location of the driver.

7. The server of claim 6, wherein the processor is further to update the real-time map to reflect a status of the driver.

8. A method for filling driver positions for a job, the method comprising:
creating, in a job repository, a job owned by a head dispatcher, the job including a total number of driver positions to fill;
sending, to at least one intermediary dispatcher, a confirmation request to confirm an assignment of the at least one intermediary dispatcher to fill an intermediary number of the total number of driver positions of the job;
responsive to an affirmative response to the confirmation request, storing a dispatcher association between the at least one intermediary dispatcher and the intermediary number of driver positions to fill;
creating, in the job repository, for each intermediary dispatcher, an intermediary job owned by the intermediary dispatcher, the intermediary job including the intermediary number of driver positions to fill;
receiving driver assignments from the head dispatcher and the at least one intermediary dispatcher;
storing, based on the driver assignments, driver associations between driver identifiers and the driver positions; and
outputting a driver roster for the job based on the driver associations, the driver roster indicating, for each driver position of the job, driver information based on the driver identifier associated with the driver position.

9. The method of claim 8, further comprising, prior to storing the driver associations, sending, to each driver associated with the driver identifiers, a driver confirmation request to confirm the driver assignment to the driver position.

10. The method of claim 9, wherein storing each driver association is only responsive to an affirmative response to the driver confirmation request.

11. The method of claim 8, wherein outputting the driver roster, comprises:
for each driver position of the job:
determining if an assigned entity for the driver position is an intermediary dispatcher or a driver;
if the assigned entity is a driver, obtaining driver information; and
if the assigned entity is an intermediary dispatcher:
obtaining an intermediary driver roster for the intermediary job owned by the intermediary dispatcher; and
substituting driver information from the intermediary driver roster for the driver in a corresponding driver position.

12. The method of claim 8, further comprising:
receiving a request from a requesting entity to view a real-time map of drivers associated with the job;
determining a viewable job owned by the requesting entity, the viewable job selected from the job and the intermediary job based on the requesting entity;
obtaining the driver roster for the viewable job; and
displaying the real-time map of drivers associated with the viewable job.

13. The method of claim 12, wherein displaying the real-time map comprises:
after receiving a start signal from a driver, receiving global positioning system (GPS) data including a location of the driver; and
updating the real-time map to reflect the location of the driver.

14. The method of claim 13, further comprising updating the real-time map to reflect a status of the driver.
